(19) United States
(12) Patent Application Publication
(10) Pub. No.: US 2002/0099465 A1
(43) Pub. Date: Jul. 25, 2002

(54) Methods and apparatus for facilitating communication between devices via an industrial network

(76) Inventor: Allen Su, Hillsboro, OR (US)

Correspondence Address: SNELL & WILMER, ONE ARIZONA CENTER, 400 EAST VAN BUREN, PHOENIX, AZ, 850040001

(21) Appl. No.: 09/766,398

(22) Filed: Jan. 19, 2001

(51) Int. Cl. G06F 19/00

(52) U.S. Cl. 700/121; 709/208

(57) ABSTRACT

The present invention includes a communication system, where devices communicate via an industrial network. A first device communicates with a second device via one or more input/output controller modules and/or controllers coupled to the industrial network. In the semiconductor industry, for example, the first device may be a CMP device and the second device may be automated material handling system (AMHS) equipment, which communicate via the industrial network and data transmission devices. The CMP device and the AMHS equipment may be coupled to the industrial network via one or more input/output controller modules and/or controllers. The industrial network may include DeviceNet™, Ethernet, and/or ProfiBus. Thus, the present invention substantially improves device to device communication, installation, maintenance, diagnostics, and repair.

### FIELD OF THE INVENTION

The present invention generally relates to communication between devices and methods for its use. More particularly, the present invention relates to communication between devices via an industrial network and methods for its use.

### BACKGROUND OF THE INVENTION

In many industries, communication between devices requires complicated circuitry, wiring, and/or controllers. A device may be a circuit level, component level, and/or system level device. A device in an automobile, for example, may need to communicate a command or data to another device in the automobile. A first device such as a chemical mechanical polishing (CMP) machine may need to communicate with a second device such as a fabrication (fab) room tool and/or a production tool. In order for the first device to communicate with the second device, there must be a medium of communication. Conventionally, the medium of communication has been a wire or cable. For example, FIG. 1 illustrates a conventional communication system 101 including a CMP machine 103 and a fab room tool (or interface) 105. CMP machine 103 and fab room tool 105 communicate via a number of wires 119, 121, and 123. CMP machine 103 includes a number of input/output controller modules 107, 109, and 1 1, which communicate with a number of input/output controller modules 113, 115, and 117 of fab room tool 105 via wires 119, 121, and 123. In this manner, each input/output controller module of CMP machine 103 communicates with each input/output controller module of fab room tool 105 via a wire or cable. In addition, each of wires 119, 121, and 123 and input/output controller modules 113, 115, and 117 need to be protected via an enclosure box 125 or individual enclosures (not shown) depending on the needs of communication system 101 (e.g., wet tool environment, electrical, mechanical, or optical interference, etc.)

However, if each CMP machine and each production tool have over a hundred input/output controller modules, then communication via over a hundred wires is impractical and cumbersome. In addition, maintenance and repair may require tedious testing in order to determine which wire needs attention. Furthermore, each wire may need to be encapsulated, if the working environment demands it (e.g., wet tool environment for semiconductor processing, electrical, mechanical, or optical interference). Thus, a method and apparatus for improved communication between the first and second devices is desirable.

### SUMMARY OF THE INVENTION

The present invention facilitates communication between devices via an industrial network. The present invention allows one or more devices to communicate using an industrial network. The devices are coupled to the industrial network via one or more input/output controller modules and/or controllers, which interface with the industrial network. The input/output controller modules and/or controllers substantially reduce complicated wiring connection schemes, and provide improved access for maintenance, repair, and diagnostics. The industrial network may include using DeviceNet™, Ethernet, and/or ProfiBus.

### BRIEF DESCRIPTION OF THE DRAWING FIGURES

The subject invention will hereinafter be described in the context of the appended drawing figures, wherein like numerals denote like elements, and:

FIG. 1 illustrates a conventional communication system including a CMP machine and a fab room tool;

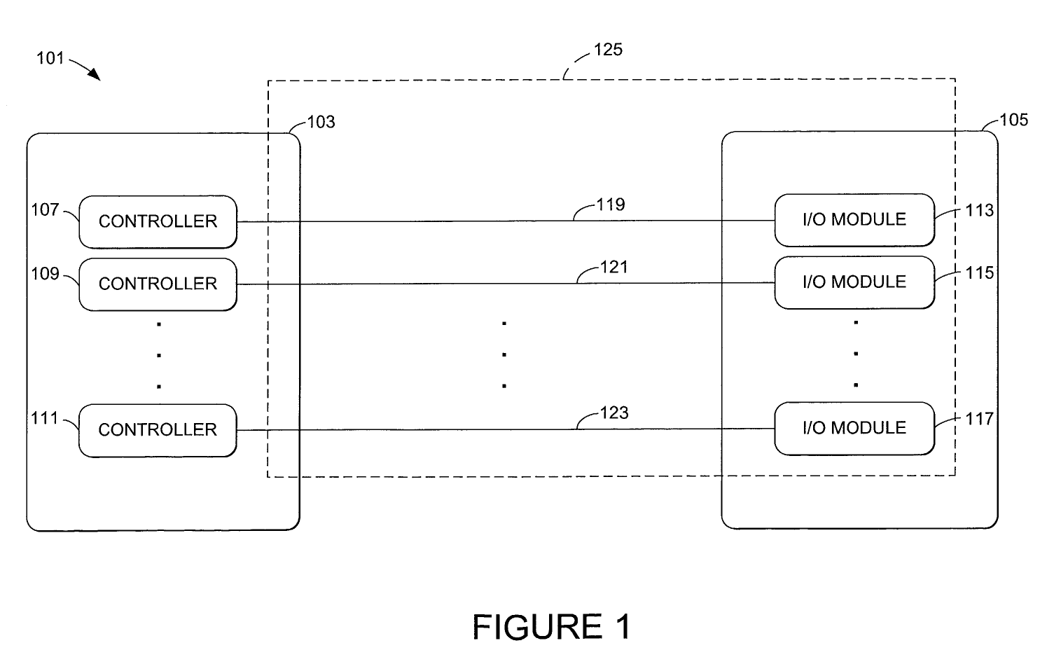

FIG. 2 illustrates a communication system in accordance with an exemplary embodiment of the present invention;

FIG. 3 illustrates a communication system in accordance with an exemplary embodiment of the present invention;

FIG. 4 illustrates a controller and an industrial network in accordance with an exemplary embodiment of the present invention; and

FIG. 5 illustrates a flowchart for a method for facilitating communication between various devices in accordance with an exemplary embodiment of the present invention.

### DETAILED DESCRIPTION

The present invention facilitates communication between devices in a variety of industries. For purposes of brevity, the present invention is discussed in the context of the semiconductor industry. However, the present invention may also be used in other industries.

The present invention may be described in terms of functional block components and various processing steps. It should be appreciated that such functional blocks may be realized by any number of hardware and/or software components configured to perform the specified functions. For example, the present invention may employ various integrated circuit components, e.g., memory elements, digital signal processing elements, look-up tables, and the like, which may carry out a variety of functions under the control of one or more microprocessors or other control devices. In addition, those skilled in the art will appreciate that the present invention may be practiced in any number of data communication contexts and that the various systems described are merely exemplary applications for various aspects of the invention. Further, it should be noted that the present invention may employ any number of conventional techniques for data transmission, training, signal processing and conditioning, and the like. Such general techniques that are known to those skilled in the art are not described in detail herein.

As will be appreciated by one of ordinary skill in the art, the present invention may be embodied as a method, a processing system, a device for processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

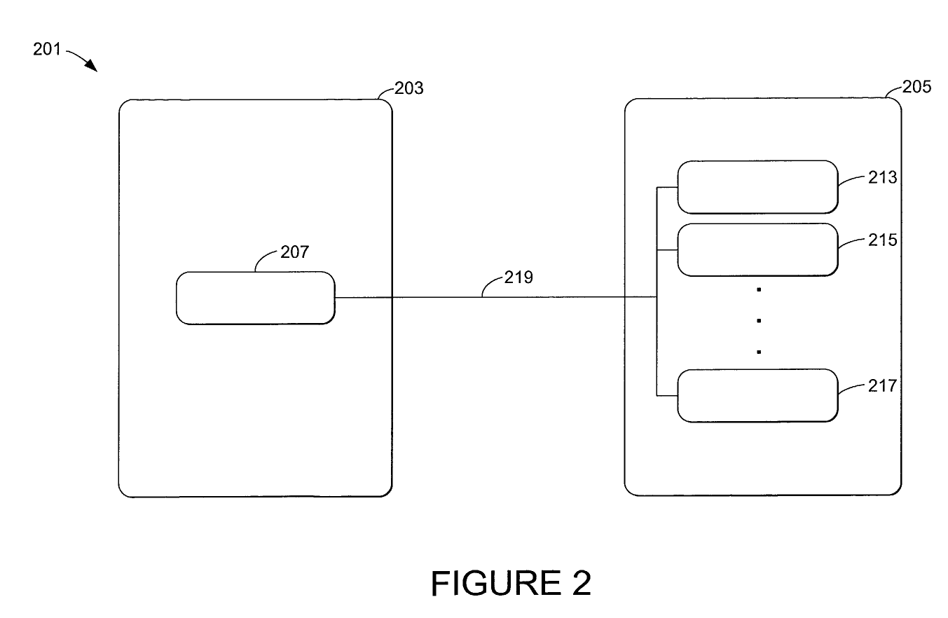

FIG. 2 illustrates a communication system 201 in accordance with an exemplary embodiment of the present invention. Communication system 201 includes a semiconductor device (or interface) 203 (e.g., a production tool such as a CMP machine, or the like), a semiconductor device (or interface) 205 (e.g., a fabrication (fab) room tool, or the like), and an industrial network 219. Semiconductor device 203 communicates or interacts with semiconductor device 205 via industrial network 219, as discussed below. Semiconductor device 203 includes an input/output controller module 207 which communicates with a number of input/output controller modules 213, 215, 217 of semiconductor device 205 via industrial network 219. Input/output controller modules 207, 213, 215, 217, individually or in combination, can be any number of input/output controller modules depending on the needs or application of communication system 201. In addition, semiconductor devices 203 and 205 may be devices other than in the semiconductor industry; however, for ease of discussion, each device is in the context of the semiconductor industry. Further, semiconductor devices 203 and 205 may be any number of devices, and are illustrated as two devices for ease of discussion. In addition, industrial network 219 may be DeviceNet™, Ethernet, and/or ProfiBus.

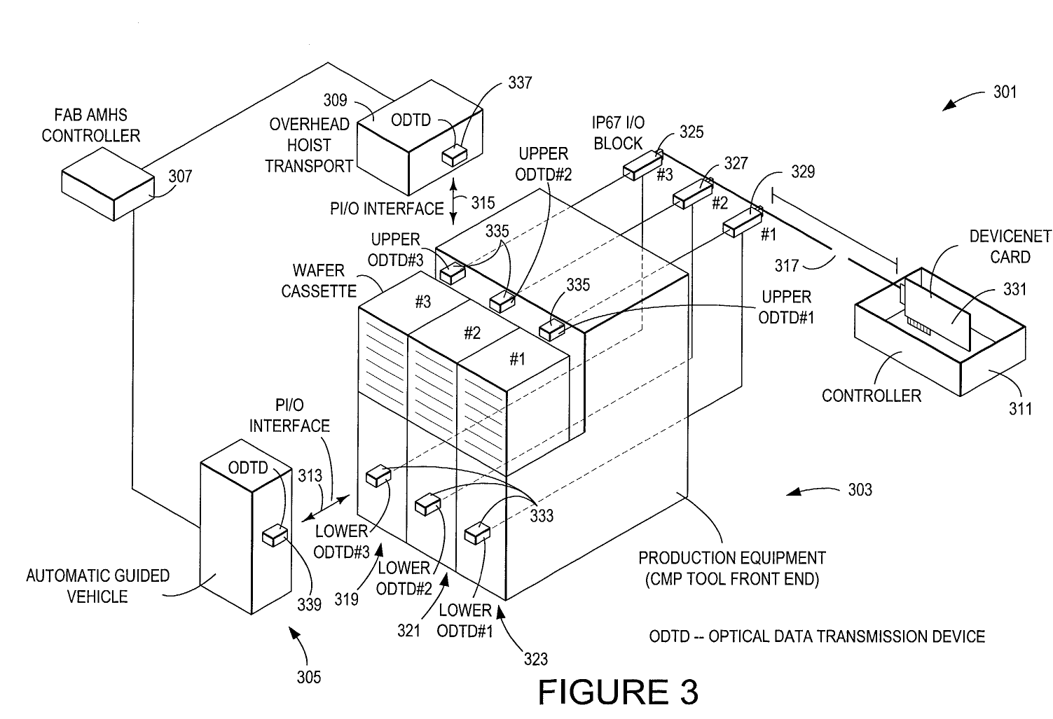

In the context of the semiconductor industry, communication system 301 of FIG. 3 illustrates the interaction between various devices including a CMP device 303, a fab automated material handling system (fab AMHS) controller 307, an overhead hoist transport 309, an automatic guided vehicle 305, and a controller 311 in accordance with an exemplary embodiment of the present invention. CMP device 303 may be a CMP device or a CMP front-end, for example. Each device may need to communicate with the other devices. For example, CMP device 303 and fab AMHS controller 307 may communicate or otherwise interface with overhead hoist transport 309, automatic guided vehicle 305, and controller 311. Semiconductor devices may load and unload components (e.g., wafers, wafer carriers, open cassettes, front opening unified pods (FOUPs), etc.). For example, wafer cassettes 319, 321, and 323 may transport wafers to or from another device. As such, CMP device 303 communicates with automatic guided vehicle 305 via a parallel input/output interface 313 and with overhead hoist transport 309 via a parallel input/output interface 315. Parallel input/output interfaces 313 and 315 may be defined by at least one of the SEMI E40, E82, E84, E87, E88, E90, E94, E99, and/or E102 specifications, or the like (“SEMI specification”). As such, communication system 301 may include a SEMI specification defined industrial network. For example, SEMI E84-0699 specification is defined in “SEMI E84-0699 Specification For Enhanced Carrier Handoff Parallel I/O Interface”, pp. 1-5 (SEMI 1999), which is hereby incorporated by reference. In addition, applications of SEMI Specifications are described in K. Gartland & E. Sherwood, “Automation Needs Reach New Levels”, Semiconductor International, pp. 157-163 (July 2000), which is hereby incorporated by reference.

In addition, a number of optical data transmission (ODT) devices 333, 335, 337, and 339 may be used to facilitate communication between automatic guided vehicle 305 (overhead hoist transport 309 and/or any other AMHS) and CMP device 303. ODT devices 333, 335, 337, and 339 communicate with a number of input/output controller modules 325, 327, and 329. For example, ODT devices 333, 335, 337, and 339 may be optical sensors, such as Hokuyo Automatic Co. E-3033-2 devices. In addition, ODT devices 333, 335, 337, and 339 may include any number of ODT devices depending on the needs of communication system 301. ODT devices 333, 335, 337, and 339 may be any type of data transmission devices, and are illustrated as optical data transmission devices for simplicity.

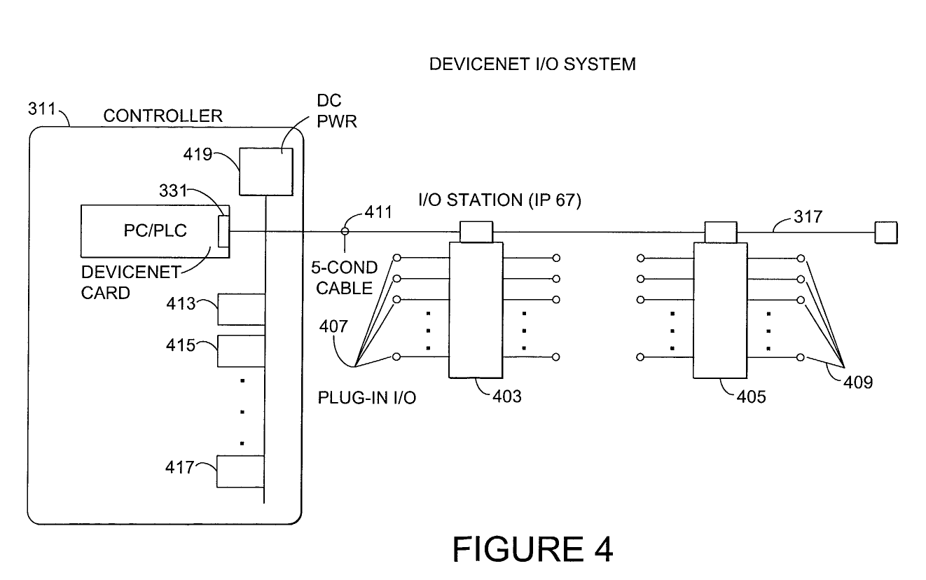

CMP device 303 and controller 311 communicate with input/output controller modules 325, 327, and 329 via an industrial network 317, for example. Controller 311 may be a controller for CMP device 303, such that controller 311 is subordinate to CMP device 303, for example. Alternatively, controller 311 may be a separate and independent device. In addition, controller 311 may encompass any number of controllers depending on the needs of communication system 301. Furthermore, controller 311 may include a number of input/output controller modules (illustrated in FIG. 4 below) such that input/output controller modules 325, 327, and 329 communicate with the input/output controller modules of controller 311 via the industrial network. Industrial network 317 may include DeviceNet™, Ethernet, and/or ProfiBus. For example, DeviceNet™ is an intelligent control network and global industry standard for connecting or linking devices to a network. DeviceNet™ improves communication between devices and allows for more efficient diagnostics. Controller 311 can include a DeviceNet™ card (or network controller) 331, for example, which controls and/or communicates with input/output controller modules 325, 327, and 329 via industrial network 317. There may be any number of input/output controller modules 325, 327, 329, e.g., sixty-three, and DeviceNet™ cards 331 depending on the needs or application of the system.

To more clearly describe controller 311 and industrial network 317, FIG. 4 illustrates controller 311 coupled to industrial network 317. For example, industrial network 317 may employ a five conductor cable 411 defined by DeviceNet™ and operating as a DeviceNet™ bus as a means of communication between industrial network 317 and controller 311. Alternatively, or in combination with a five conductor cable, industrial network 317 may be any other medium of communication including electrical media, mechanical media, optical media, wireless media, and/or the like.

Industrial network 317 also includes various input/output controller modules 403 and 405, which provide a means of communication with controller 311. Input/output controller modules 403 and 405 include a number of input/output plug-ins 407 and 409 (e.g., ODT devices 333, 335, 337, and 339), respectively, for connection with various devices, e.g., sensors. There may be any number of input/output controller modules 403 and/or 405 having any number of plug-ins 407 and/or 409 depending on the needs of the system. For example, input/output plug-ins 407 and/or 409 include any number of plug-ins for one or more devices, such as CMP device 303, overhead hoist transport 309 of FIG. 3, and/or other devices (e.g., other AMHS devices, production tools, and/or the like). In this manner, input/output plug-ins 407 and 409 facilitate communication between various devices. In addition, controller 311 may include any number of input/output controller modules (or network controllers) 413, 415, and 417, which may communicate with input/output controller modules 325, 327, and 329 of FIG. 3 via industrial network 317 (e.g., a network bus, a DeviceNet™ bus, and/or the like). In addition, controller 311 includes a DC power supply 419, or alternatively, DC power supply 419 may be an external source.

Whereas, CMP device 303 may have required over one hundred wires connecting input/output controller modules 325, 327, and 329 to controller 311 in order to communicate, communication system 301 allows for communication via controller 311 and industrial network 317. As such, installation, communication, testing, diagnostics, maintenance, and repair of communication system 301 of FIG. 3 is substantially simplified and improved. In addition, input/output controller modules 403 and 405 and/or industrial network 317 can substantially support a wet tool environment and substantially guard against electrical, mechanical, and optical interference, such that enclosure boxes and/or complicated protective devices are essentially not required.

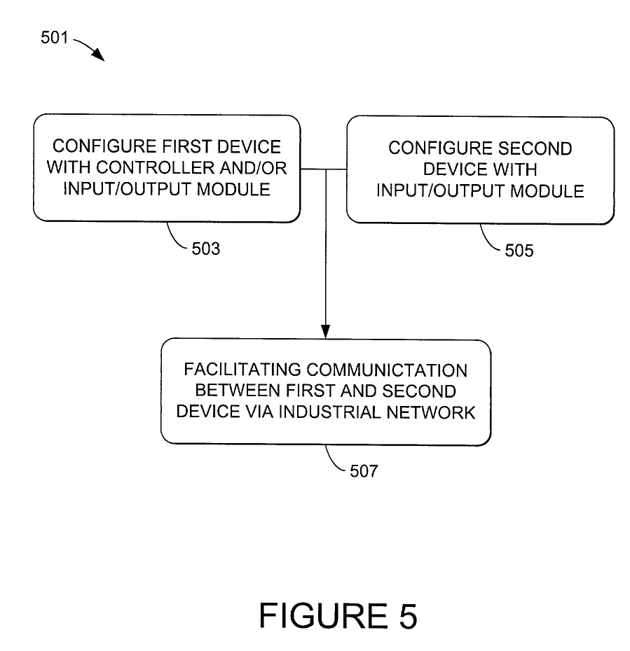

The flowchart 501 of FIG. 5 illustrates a method for facilitating communication between various devices, such as CMP device 303, automatic guided vehicle 305, fab AHMS controller 307, overhead hoist transport 309, and/or controller 311 of FIG. 3 in accordance with an exemplary embodiment of the present invention. The method of FIG. 5 may be used for any number of devices in any number of industries depending on the needs and application of the system.

Flowchart 501 includes configuring a first device (e.g., a semiconductor device (or interface), such as CNP device 303) to have a controller (step 503). Alternatively, or in combination, the first device may include one or more first input/output controller modules (e.g., input/output controller modules 403 and/or 405) and/or ODT devices 333 and 335. As such, facilitating communication between one or more first input/output controller modules (and/or ODT devices 333, 335, 337, and 339) and the controller may be via an industrial network. Optionally, a second semiconductor device (e.g., automatic guided vehicle 305) may be configured to have one or more second input/output controller modules (e.g., ODT devices 333, 335, 337, and 339) (step 505). The first and second devices may be configured to have any number of input/output controller modules depending on the needs of communication system 301. Communication between the first input/output controller module and the second input/output controller module is facilitated via an industrial network (e.g., industrial network 317) and/or ODT devices 333, 335, 337, and 339. Communication between the first and second input/output controller modules may be facilitated via DeviceNet™, Ethernet, a SEMI specification defined network, and/or ProfiBus. Thus, facilitating communication between the first and second devices may be via an industrial network (step 507), including DeviceNet™, Ethernet, a SEMI specification defined network, and/or ProfiBus.

Thus, the present invention provides methods and apparatus for facilitating communication between devices. Communication between various devices is via an industrial network. For example, devices may be coupled to the industrial network via one or more input/output controller modules and/or controllers. In this manner, communication between devices may be via the input/output controller modules and/or controllers, which are substantially environmental proof and substantially protected from electrical, mechanical, and optical interference. Thus, the present invention substantially improves device to device communication, installation, maintenance, diagnostics, and repair.

Although the invention has been described herein with reference to the appended drawing figures, it will be appreciated that the scope of the invention is not so limited. Various modifications in the design and implementation of various components and method steps discussed herein may be made without departing from the spirit and scope of the invention, as set forth in the appended claims. No element described herein is necessary for the practice of the invention, unless the element is expressly described herein as “essential” or “required”. Steps recited in any method claims may be executed in any order.

What is claimed is:

1. An apparatus for communicating between a first device and a second device, comprising:
a controller of the second device in communication with the first device; and
an industrial network coupled between the first device and the controller to facilitate communication between the first and second devices.

2. The apparatus of claim 1, further comprising at least one first input/output controller module of the first device in communication with the controller via the industrial network in order to facilitate communication between the first and second devices.

3. The apparatus of claim 2, wherein the at least one first input/output controller module communicates with the controller via at least one of DeviceNet, Ethernet, a SEMI specification defined network, or ProfiBus.

4. The apparatus of claim 3, wherein the first and second devices are semiconductor devices and the SEMI specification is SEMI E84.

5. The apparatus of claim 2, wherein:
communication between the first and second devices is via at least one of DeviceNet, Ethernet, a SEMI specification defined network, or ProfiBus; and
communication between the at least one first input/output controller module and the controller is via at least one of DeviceNet, Ethernet, a SEMI specification defined network, or ProfiBus.

6. The apparatus of claim 1, further comprising:
at least one first input/output controller module of the first device; and
at least one second input/output controller module of the second device, wherein the at least one first input/output controller module communicates with the at least one second input/output controller module via a SEMI specification defined network.

7. The apparatus of claim 6, wherein the communication between the at least one first input/output controller module and the at least one second input/output controller module is via at least one of DeviceNet, Ethernet, or ProfiBus.

8. The apparatus of claim 6, wherein:
the first and second devices are semiconductor devices;
the communication between the first and second devices is via at least one of DeviceNet, Ethernet, a SEMI specification defined network, or ProfiBus; and
the communication between the at least one first input/output controller module and the at least one second input/output controller module is via at least one of DeviceNet, Ethernet, a SEMI specification defined network, or ProfiBus.

9. The apparatus of claim 1, further comprising at least one parallel input/output interface coupled between the first and second devices.

10. The apparatus of claim 9, wherein the at least one parallel input/output interface includes at least one optical data transmission device.

11. The apparatus of claim 1, wherein the first device includes an automated material handling system and the second device includes at least one of a CMP device or production equipment.

12. The apparatus of claim 1, wherein the first and second devices are semiconductor devices.

13. A method of communication between a first semiconductor device and a second semiconductor device, comprising the steps of:
configuring the second semiconductor device to have a controller; and
providing communication between the first device and the controller via an industrial network in order to facilitate communication between the first and second devices.

14. The method of claim 13, further comprising the steps of:
configuring the first semiconductor device to have at least one first input/output controller module; and
facilitating communication between the at least one first input/output controller module and the controller via at least one of DeviceNet, Ethernet, a SEMI specification defined network, or ProfiBus.

15. The method of claim 13, further comprising the steps of:
configuring the first semiconductor device to have at least one first input/output controller module;
configuring the second semiconductor device to have at least one second input/output controller module; and
facilitating communication between the at least one first input/output controller module and the at least one second input/output controller module via the industrial network.

16. The method of claim 15, wherein:
communication between the first and second devices is via at least one of DeviceNet, Ethernet, a SEMI specification defined network, or ProfiBus; and
facilitating communication between the at least one first input/output controller module and the at least one second input/output controller module is via at least one of DeviceNet, Ethernet, a SEMI specification defined network, or ProfiBus.

17. The method of claim 15, wherein:
the first semiconductor device includes an automated material handling system;
the second semiconductor device includes at least one of a CMP device or production equipment;
facilitating communication between the first and second semiconductor devices is via at least one of DeviceNet, Ethernet, a SEMI specification defined network, or ProfiBus; and
facilitating communication between the at least one first input/output controller module and the at least one second input/output controller module is via at least one of DeviceNet, Ethernet, a SEMI specification defined network, or ProfiBus.

18. The method of claim 13, further comprising the step of coupling at least one of parallel input/output interface or optical data transmission device between the first and second devices.

19. The method of claim 13, wherein facilitating communication between the first and second semiconductor devices is via at least one of DeviceNet, Ethernet, a SEMI specification defined network, or ProfiBus.

20. The method of claim 13, wherein:
the first semiconductor device includes an automated material handling system; and
the second semiconductor device includes at least one of a CMP device or production equipment.

21. A method of communication between a CMP device and a second semiconductor device, comprising the steps of:
manipulating an industrial network to facilitate a SEMI specification defined parallel input/output interface between the CMP device and the second semiconductor device; and
facilitating communication between the CMP and second semiconductor device via the industrial network.

22. The method of claim 21, further comprising the step of facilitating communication between the CMP and second semiconductor device via at least one of DeviceNet, Ethernet, or ProfiBus.

23. A semiconductor system, comprising:
a first semiconductor device configured as a chemical mechanical polishing device having at least one controller;
a second semiconductor device configured as a production tool having at least one input/output controller module; and
an industrial network for facilitating communication between the at least one controller and the at least one second input/output controller module.

24. The semiconductor system of claim 23, wherein facilitating communication between the at least one controller and the at least one second input/output controller module is via at least one of DeviceNet, Ethernet, a SEMI specification defined network, or ProfiBus.
